(19) United States
(12) Patent Application Publication
(10) Pub. No.: US 2020/0358133 A1
(43) Pub. Date: Nov. 12, 2020

(54) ALL SOLID STATE BATTERY

(71) Applicant: Murata Manufacturing Co., Ltd., Nagaokakyo-shi (JP)

(72) Inventors: Akira Baba, Nagaokakyo-shi (JP); Takayuki Nagano, Nagaokakyo-shi (JP)

(21) Appl. No.: 16/941,747

(22) Filed: Jul. 29, 2020

Related U.S. Application Data
(63) Continuation of application No. PCT/JP2019/006940, filed on Feb. 25, 2019.

(30) Foreign Application Priority Data
Mar. 2, 2018 (JP) 2018-037224

(51) Int. Cl. H01M 10/0562; H01M 2/26

(52) U.S. Cl. CPC H01M 10/0562; H01M 2/26

(57) ABSTRACT

An all solid state battery that includes a sintered body, a first external electrode, a second external electrode, a first metal member, and a second metal member. The first metal member is electrically connected to the first external electrode and has a first reflow-mounting portion. The second metal member is electrically connected to the second external electrode and has a second reflow-mounting portion. A first wet plating layer is on at least a portion of a surface of the first reflow-mounting portion, and a second wet plating layer is on at least a portion of a surface of the second reflow-mounting portion.

### CROSS REFERENCE TO RELATED APPLICATIONS

The present application is a continuation of International application No. PCT/JP2019/006940, filed Feb. 25, 2019, which claims priority to Japanese Patent Application No. 2018-037224, filed Mar. 2, 2018, the entire contents of each of which are incorporated herein by reference.

### FIELD OF THE INVENTION

The present invention relates to an all solid state battery.

### BACKGROUND OF THE INVENTION

Patent Document 1 describes an all solid state battery in which a plating layer is formed on an outermost layer of a terminal electrode so that reflow mounting using solder is possible.

However, when a plating layer is formed on the outermost layer of the terminal electrode, a plating solution may enter a device. Thus, an all solid state battery having desired characteristics may not be obtained. Thus, it is practically difficult to form a plating layer on an outermost layer of a terminal electrode so that reflow mounting using solder is possible, as described in Patent Document 1.

Patent Document 1: Japanese Patent Application Laid-Open No. 2017-183052

### SUMMARY OF THE INVENTION

A main object of the present invention is to provide an all solid state battery that can be reflow-mounted using solder.

An all solid state battery according to one aspect of the present invention includes a sintered body, a first external electrode, a second external electrode, a first metal member, and a second metal member. The sintered body has a first internal electrode, a second internal electrode facing the first internal electrode, and a electrolyte layer between the first internal electrode and the second internal electrode. The first external electrode is on a surface of the sintered body and is electrically connected to the first internal electrode. The second external electrode is on the surface of the sintered body and is electrically connected to the second internal electrode. The first metal member is electrically connected to the first external electrode and has a first reflow-mounting portion. The second metal member is electrically connected to the second external electrode and has a second reflow-mounting portion. A first wet plating layer is on at least a portion of a surface of the first reflow-mounting portion, and a second wet plating layer is on at least a portion of a surface of the second reflow-mounting portion.

### BRIEF EXPLANATION OF THE DRAWINGS

FIG. 1 is a schematic perspective view of an all solid state battery according to a first embodiment.

FIG. 2 is a schematic cross-sectional view taken along line II-II of FIG. 1.

FIG. 3 is a schematic cross-sectional view of an all solid state battery according to a second embodiment.

FIG. 4 is a schematic cross-sectional view of an all solid state battery according to a third embodiment.

FIG. 5 is a schematic cross-sectional view of an all solid state battery according to a fourth embodiment.

### DETAILED DESCRIPTION OF THE INVENTION

Hereinafter, a description will be given of an example of a preferred embodiment of the present invention. However, the following embodiments are provided merely by way of example. The present invention is not limited to the following embodiments.

Throughout the drawings to which the embodiments and the like refer, elements having substantially the same functions will be referred to by the same reference symbols. The drawings to which the embodiments and the like refer are schematically illustrated. The dimensional ratios and the like of objects illustrated in the drawings may be different from those of the actual objects.

Different drawings may have different dimensional ratios and the like of the objects. Dimensional ratios and the like of specific objects should be determined in consideration of the following descriptions.

### First Embodiment

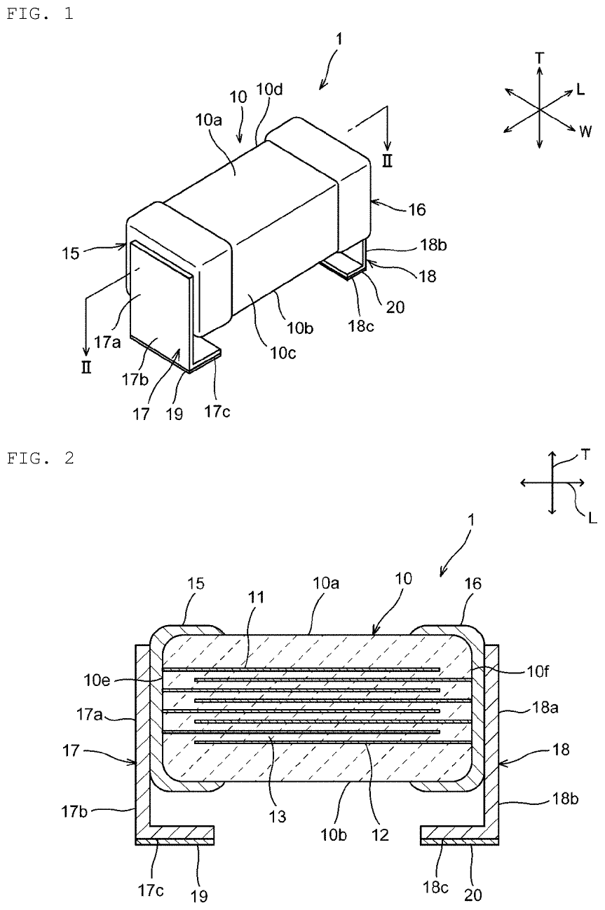

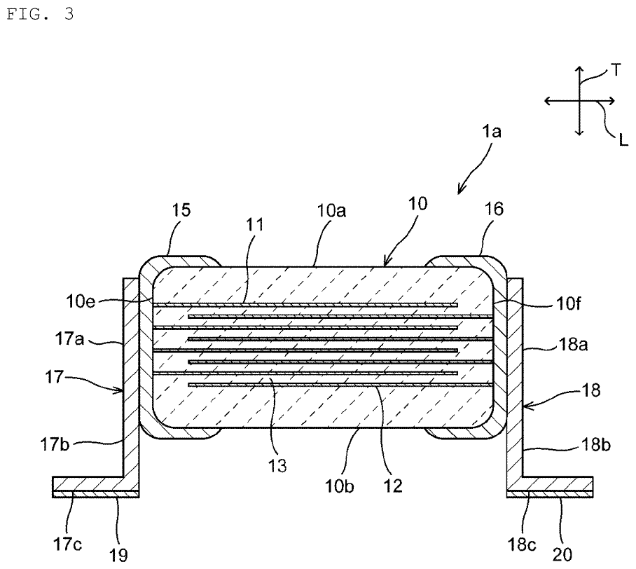

FIG. 1 is a schematic perspective view of an all solid state battery 1 according to the present embodiment. FIG. 2 is a schematic cross-sectional view taken along line II-II of FIG. 1.

The all solid state battery 1 shown in FIG. 1 is a battery which has a solid electrolyte and not a liquid electrolyte, and in which all components are solid. In the present embodiment, specifically, an example in which the all solid state battery 1 is an all-solid-state lithium-ion secondary battery will be described. However, the all solid state battery according to the present invention may be an all solid state battery other than the lithium ion secondary battery.

As shown in FIGS. 1 and 2, the all solid state battery 1 includes a sintered body 10. The sintered body 10 has a substantially rectangular parallelepiped shape. The sintered body 10 includes first and second principal surfaces 10a and 10b, first and second side surfaces 10c and 10d, and first and second end surfaces 10e and 10f. The first and second principal surfaces 10a and 10b extend along a length direction L and a width direction W, respectively. The width direction W is perpendicular to the length direction L. The first and second side surfaces 10c and 10d extend along the length direction L and the thickness direction T, respectively. The thickness direction T is perpendicular to each of the length direction L and the width direction W. Each of the first and second end surfaces 10e and 10f extends along the width direction W and the thickness direction T. Ridges and corners of the sintered body 10 may be chamfered or rounded, and from the viewpoint of suppressing occurrence of cracks, the rounded shape may be preferable.

As shown in FIG. 2, the sintered body 10 includes a positive electrode 11 constituting a first internal electrode and a negative electrode 12 facing the positive electrode 11 and constituting a second internal electrode.

The positive electrode 11 is exposed to a first end surface 10e, but is not exposed to a second end surface 10f.

The negative electrode 12 is exposed to the second end surface 10f, but is not exposed to the first end surface 10e.

The positive electrode 11 may be configured by, for example, a positive electrode active material layer, or may be configured by a positive electrode current collector layer and a positive electrode active material layer provided on the positive electrode current collector layer.

The positive electrode current collector layer contains a conductive material such as a carbon material or a metal material. Specific examples of preferably used carbon materials include graphite and carbon nanotubes. Specific examples of preferably used metal materials include Cu, Mg, Ti, Fe, Co, Ni, Zn, Al, Ge, In, Au, Pt, Pd and alloys including these metal materials. The positive electrode current collector layer may further include a binder, a solid electrolyte, and the like in addition to the conductive material.

The positive electrode active material layer contains a positive electrode active material. Examples of preferably used positive electrode active materials include lithium transition metal composite oxides and lithium transition metal phosphate compounds. Specific examples of the lithium transition metal composite oxides include LiCoO₂, LiNiO₂, LiVO₂, LiCrO₂, and LiMn₂O₄. Specific examples of the lithium transition metal phosphate compounds include LiFePO₄ and LiCoPO₄. The positive electrode active material layer may further include a binder, a conductive material, a solid electrolyte, and the like in addition to the positive electrode active material.

The negative electrode 12 may be configured by, for example, a negative electrode active material layer, or may be configured by a negative electrode current collector layer and a negative electrode active material layer provided on the negative electrode current collector layer.

The negative electrode current collector layer contains a conductive material such as a carbon material or a metal material. Examples of carbon materials and metal materials preferably used for the negative electrode current collector layer include the same carbon materials and metal materials as those preferably used for the positive electrode current collector layer described above.

The negative electrode current collector layer may further include a binder, a solid electrolyte, and the like in addition to the conductive material.

The negative electrode active material layer contains a negative electrode active material. Examples of preferably used negative electrode active materials include a carbon material, a metal material, a semimetal material, a lithium transition metal composite oxide, and lithium metal. Specific examples of carbon materials preferably used as the negative electrode active material include graphite, easily graphitizable carbon, non-graphitizable carbon, graphite, mesocarbon microbeads (MCMB), and highly oriented graphite (HOPG). Specific examples of metal materials and semimetal materials preferably used as the negative electrode active material include Si, Sn, SiB₄, TiSi₂, SiC, Si₃N₄, SiOᵥ (0<v≤2), LiSiO, SnO_{w} (0<w≤2), SnSiO₃, LiSnO, and Mg₂Sn. Specific examples of lithium transition metal composite oxides preferably used as the negative electrode active material include Li₄Ti₅O₁₂. The negative electrode active material layer may further include a binder, a conductive material, a solid electrolyte, and the like in addition to the negative electrode active material.

A solid electrolyte layer 13 is provided between the positive electrode 11 and the negative electrode 12.

Specifically, in the present embodiment, a plurality of the positive electrodes 11 and a plurality of the negative electrodes 12 are alternately stacked with the solid electrolyte layer 13 interposed therebetween.

The solid electrolyte layer 13 contains a solid electrolyte. Specific examples of preferably used solid electrolytes include sulfides such as Li₂S—P₂S₅, Li₂S—SiS₂—Li₃PO₄, Li₇P₃S₁₁, Li_{3.25}Ge_{0.25}P_{0.75}S, and Li₁₀GeP₂S₁₂, oxides such as Li₇ La₃Zr₂O₁₂, Li_{6.75}La₃Zr_{1.75}Nb_{0.25}O₁₂, Li₆BaLa₂Ta₂O₁₂, Li₁₊ₓAlₓTi₂₋ₓ(PO₄)₃, and La_{2/3-x}Li₃ₓTiO₃, and polymer materials such as polyethylene oxide (PEO). The solid electrolyte layer 13 may further include a binder and the like in addition to the solid electrolyte. In the present embodiment, it is more preferable to use an oxide as the solid electrolyte. In this case, the safety of the solid electrolyte can be improved.

On a surface of the sintered body 10, first and second external electrodes (terminal electrodes) 15 and 16 are provided.

The first external electrode 15 is provided on a surface of the first end surface 10e of the sintered body 10. Specifically, the first external electrode 15 is provided on the first end surface 10e and provided over the first and second principal surfaces 10a and 10b and the first and second side surfaces 10c and 10d. The first external electrode 15 is electrically connected to the plurality of positive electrodes 11 exposed from the first end surface 10e.

The second external electrode 16 is provided on a surface of the second end surface 10f of the sintered body 10. Specifically, the second external electrode 16 is provided on the second end surface 10f and provided over the first and second principal surfaces 10a and 10b and the first and second side surfaces 10c and 10d. The second external electrode 16 is electrically connected to the plurality of negative electrodes 12 exposed from the second end surface 10f. The first and second external electrodes 15 and 16 include a conductive material such as a metal material. Examples of metal materials preferably used for the external electrodes 15 and 16 include Ag, Au, Pt, Al, Cu, Sn, Ni, and alloys containing these metals. The external electrodes 15 and 16 may further include a binder, a solid electrolyte, and the like in addition to the conductive material.

In the present embodiment, the first and second external electrodes 15 and 16 are formed by thermosetting a powder of a conductive material and a thermosetting resin. That is, the first and second external electrodes 15 and 16 are constituted of a cured object of a thermosetting resin in which the powder of the conductive material is dispersed. The first and second external electrodes 15 and 16 do not have a wet plating layer.

A substantially L-shaped first metal member 17 is electrically connected to the first external electrode 15. The first metal member 17 is connected to the first external electrode 15 by, for example, a conductive paste or laser welding.

The first metal member 17 has a first connecting portion 17a, a first extending portion 17b, and a first mounting portion 17c (a first reflow-mounting portion).

The first connecting portion 17a is connected to the first external electrode 15. In the present embodiment, the first connecting portion 17a is provided on a portion of the first external electrode 15 that is on the end surface 10e of the sintered body 10.

The first extending portion 17b is connected to the first connecting portion 17a. The first extending portion 17b extends from the first connecting portion 17a and away from the sintered body 10 along the thickness direction T of the sintered body 10.

The first mounting portion 17c is connected to a tip of the first extending portion 17b.

The first mounting portion 17c is a portion mounted on a mounting board or the like using solder or the like.

The first mounting portion 17c extends along the length direction L toward an inner side of the sintered body 10, that is, toward the second end surface 10f. Thus, the first mounting portion 17c has at least a portion thereof that overlaps the sintered body 10 in a plan view of the all solid state battery 1.

A metal constituting the first metal member 17 is not particularly limited. Examples of metals constituting the first metal member 17 include SUS, copper, and aluminum.

A substantially L-shaped second metal member 18 is electrically connected to the second external electrode 16. The second metal member 18 is connected to the second external electrode 16 by, for example, a conductive paste or laser welding.

The second metal member 18 has a second connecting portion 18a, a second extending portion 18b, and a second mounting portion 18c (a first reflow-mounting portion).

The second connecting portion 18a is connected to the second external electrode 16. In the present embodiment, the second connecting portion 18a is provided on a portion of the second external electrode 16 that is on the end surface 10f of the sintered body 10.

The second extending portion 18b is connected to the second connecting portion 18a. The second extending portion 18b extends from the second connecting portion 18a and away from the sintered body 10 along the thickness direction T of the sintered body 10.

The second mounting portion 18c is connected to a tip of the second extending portion 18b.

The second mounting portion 18c is, for example, a portion mounted on a mounting board or the like using solder or the like.

The second mounting portion 18c extends along the length direction L toward the inner side of the sintered body 10, that is, toward the first end surface 10e. Thus, the second mounting portion 18c has at least a portion thereof that overlaps the sintered body 10 in the plan view of the all solid state battery 1.

A metal constituting the second metal member 18 is not particularly limited. Examples of metals constituting the second metal member 18 include SUS, copper, and aluminum.

The thickness of the first and second metal members 17 and 18 is preferably 500 μm or less, more preferably 300 μm or less, and still more preferably 200 μm or less. When the first and second metal members 17 and 18 have such a thickness, flexibility of the first and second metal members 17 and 18 is improved. Thus, when the all solid state battery 1 is mounted on a mounting board or the like, even if stress is applied to the all solid state battery 1, it is possible to suppress the impact on the sintered body 10 and the external electrodes 15 and 16. However, if the thickness of the first and second metal members 17 and 18 is too thin, the first and second metal members 17 and 18 may be deformed. Thus, the thickness of the first and second metal members 17 and 18 is preferably 50 μm or more, more preferably 100 μm or more, and still more preferably 150 μm or more.

On the first mounting portion 17c of the first metal member 17, a first wet plating layer 19 is provided. Specifically, the first wet plating layer 19 is provided on a surface of the first mounting portion 17c opposite to the sintered body 10 in the thickness direction T. In the present embodiment, the first wet plating layer 19 is provided on the entire surface of the first mounting portion 17c opposite to the sintered body 10 in the thickness direction T. However, the present invention is not limited to this configuration. The first wet plating layer 19 may be provided on at least a portion of the surface of the first mounting portion 17c opposite to the sintered body 10 in the thickness direction T.

A configuration of the first wet plating layer 19 is not particularly limited as long as the first wet plating layer 19 is bonded to solder. The first wet plating layer 19 may be comprised of, for example, an Ni plating layer on a surface of the first mounting portion 17c, a Pd plating layer on the Ni plating layer, and an Au plating layer on the Pd plating layer. The first wet plating layer 19 may also be comprised of, for example, an Ni plating layer on the surface of the first mounting portion 17c, an Ag plating layer on the Ni plating layer, and an Sn plating layer on the Ag plating layer. The first wet plating layer 19 also may be comprised of, for example, an Ni plating layer on the surface of the first mounting portion 17c, an Sn plating layer on the Ni plating layer, and an Au plating layer on the Sn plating layer.

On the second mounting portion 18c of the second metal member 18, a second wet plating layer 20 is provided. Specifically, the second wet plating layer 20 is provided on a surface of the second mounting portion 18c opposite to the sintered body 10 in the thickness direction T. In the present embodiment, the second wet plating layer 20 is provided on the entire surface of the second mounting portion 18c opposite to the sintered body 10 in the thickness direction T. However, the present invention is not limited to this configuration. The second wet plating layer 20 may be provided on at least a portion of the surface of the second mounting portion 18c opposite to the sintered body 10 in the thickness direction T.

A configuration of the second wet plating layer 20 is not particularly limited as long as the second wet plating layer 20 is bonded to solder. The second wet plating layer 20 may be comprised of, for example, an Ni plating layer on the second mounting portion 18c, a Pd plating layer on the Ni plating layer, and an Au plating layer on the Pd plating layer. The second wet plating layer 20 may also be comprised of, for example, an Ni plating layer on the surface of the second mounting portion 18c, an Ag plating layer on the Ni plating layer, and an Sn plating layer on the Ag plating layer. The second wet plating layer 20 also may be comprised of, for example, an Ni plating layer on the surface of the second mounting portion 18c, an Sn plating layer on the Ni plating layer, and an Au plating layer on the Sn plating layer.

As described above, the all solid state battery 1 includes the first metal member 17 electrically connected to the first external electrode 15 and the second metal member 18 electrically connected to the second external electrode 16. Each of the first and second external electrodes 15 and 16 does not have a wet plating layer in direct contact therewith, and the wet plating layers 19 and 20 are formed on at least a portion of the surfaces of the first and second metal members 17 and 18.

For example, when a wet plating layer is provided on an outermost layer of an external electrode of an all solid state battery so that reflow mounting using solder is possible, a plating solution may enter the inside of a chip in a step of providing the wet plating layer. Thus, it is difficult to enable reflow mounting using solder by providing a wet plating layer in an external electrode.

On the other hand, in the all solid state battery 1, the first and second metal members 17 and 18 are provided with the wet plating layers 19 and 20. Thus, in the first and second metal members 17 and 18, the all solid state battery 1 can be reflow-mounted on a mounting board using solder. Thus, there is no need to form a wet plating layer on the external electrodes 15 and 16. Thus, in the all solid state battery 1, there is no possibility that the plating solution enters the inside of the chip. Thus, desired characteristics can be obtained even when the all solid state battery 1 is reflow-mounted on a substrate or the like using solder.

In the all solid state battery 1, at least a portion of the mounting portions 17c and 18c overlap the sintered body 10 in the plan view of the all solid state battery 1. Thus, when the all solid state battery 1 is mounted on a substrate or the like, the mounting portions 17c and 18c are located below the sintered body 10. Thus, a mounting area of the all solid state battery 1 can be reduced.

Referring to FIGS. 1 and 2, the first metal member 17 is fixed (connected) to a portion of the first external electrode 15 formed on the first end surface 10e, and the second metal member 18 is fixed (connected) to a portion of the second external electrode 16 formed on the second end surface 10f. However, the present invention is not limited to this configuration. For example, the first metal member 17 may be fixed (connected) to a portion of the first external electrode 15 formed on the second principal surface 10b, and the second metal member 18 may be fixed (connected) to a portion of the second external electrode 16 formed on the second principal surface 10b. In this case, the first metal member 17 and the second metal member 18 are not L-shaped, but have different shapes (for example, a horizontal U-shape).

### Method for Manufacturing All Solid State Battery 1

Next, an example of a method for manufacturing the all solid state battery 1 will be described.

First, a slurry is prepared by mixing a solid electrolyte, an organic binder, a solvent and an additive. Thereafter, the slurry is applied on a resin sheet or the like and dried to produce a green sheet.

Next, a positive electrode paste and a negative electrode paste are prepared.

The positive electrode paste is obtained by mixing a solid electrolyte, a conductive auxiliary, an organic binder, a solvent, an additive, and the like, if necessary, in addition to a positive electrode active material.

The negative electrode paste is obtained by mixing a solid electrolyte, a conductive auxiliary, an organic binder, a solvent, an additive, and the like, if necessary, in addition to a negative electrode active material.

Next, the obtained positive electrode paste or negative electrode paste is printed on a green sheet to obtain a positive electrode green sheet and a negative electrode green sheet. An insulating layer may be provided on a portion of the green sheet where the positive electrode paste or the negative electrode paste is not printed.

Next, the positive electrode green sheet and the negative electrode green sheet are alternately stacked, and insulating layers are then provided above and below the stack to produce a laminate. As the insulating layer, the above-described solid electrolyte sheet may be used, or a sheet having a composition different from that of the solid electrolyte may be used.

The obtained laminate is divided into a plurality of chips to obtain raw chips. An external electrode paste is applied on the raw chip and dried.

The sintered body 10 is obtained by degreasing and firing the raw chip to which the external electrode paste is applied.

Next, the metal members 17 and 18 are prepared. The metal members 17 and 18 can be formed, for example, in the following manner. First, the mounting portions 17c and 18c are each formed by bending a metal plate into an L shape. The wet plating layers 19 and 20 are formed on the mounting portions 17c and 18c.

Next, the metal members 17 and 18 are attached to the external electrodes 15 and 16. The metal members 17 and 18 can be attached to the external electrodes 15 and 16 in the following manner, for example. First, a conductive paste containing a conductive powder is applied onto a surface of a portion of the external electrodes 15 and 16 to which the metal members 17 and 18 are to be attached.

The metal members 17 and 18 are closely attached to the portion to which the conductive paste is applied, and dried. Next, the metal members 17 and 18 are secured to the external electrodes 15 and 16 by heating to 200° C. When a metal terminal is attached to the external electrode, the same conductive paste as that used for forming the external electrode may be used, or a different conductive paste may be used.

The all solid state battery 1 according to the present embodiment can be obtained by the above production method.

Hereinafter, a description will be given of another example of a preferred embodiment of the present invention. In the following description, members having substantially the same functions as those of the first embodiment will be referred to using the same symbols and description thereof will be omitted.

### Second Embodiment

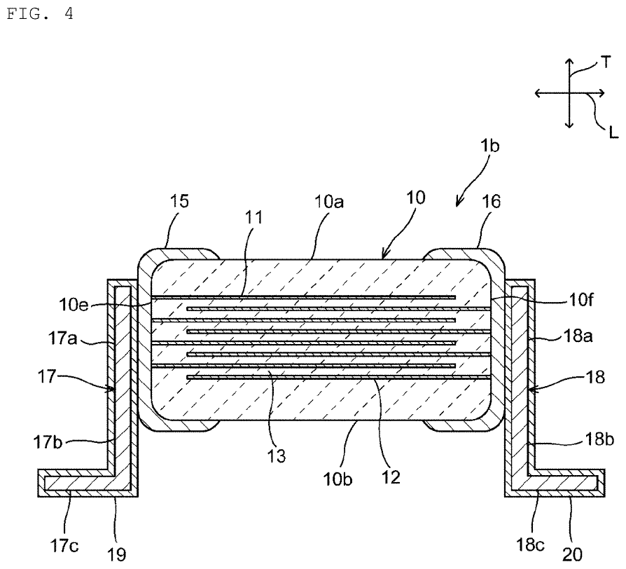

FIG. 3 is a schematic cross-sectional view of an all solid state battery 1a according to a second embodiment. In the first embodiment, the example has been described in which at least a portion of the first and second mounting portions 17c and 18c is provided so as to overlap the sintered body 10 in the plan view of the all solid state battery 1. However, the present invention is not limited to this configuration.

In the all solid state battery 1a, the first mounting portion 17c extends along a length direction L toward a side opposite to the second mounting portion 18c. The second mounting portion 18c extends along the length direction L toward a side opposite to the first mounting portion 17c. Even in this case, it is possible to provide the all solid state battery 1a that can be reflow-mounted using solder.

### Third Embodiment

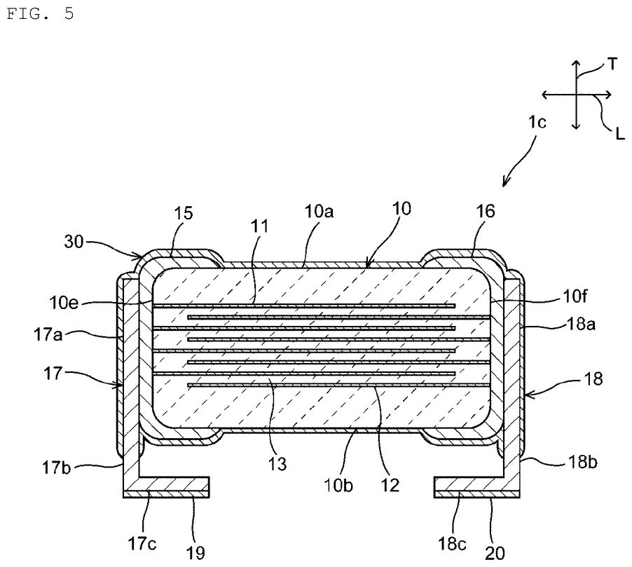

FIG. 4 is a schematic cross-sectional view of an all solid state battery 1b according to a third embodiment.

In the first and second embodiments, the example has been described in which the wet plating layers 19 and 20 are provided only in the mounting portions 17c and 18c. However, the present invention is not limited to this configuration.

As shown in FIG. 4, in the all solid state battery 1b, the first and second wet plating layers 19 and 20 are provided on the entire surfaces of first and second metal members 17 and 18, respectively. In this case, it is easy to form the wet plating layers 19 and 20 on the first and second metal members 17 and 18. Thus, manufacture of the all solid state battery 1b is easy. When reflow mounting is performed using solder, a bonding area between the solder and the metal members 17 and 18 is increased, so that mounting strength is improved.

### Fourth Embodiment

FIG. 5 is a schematic cross-sectional view of an all solid state battery 1c according to a fourth embodiment. The all solid state battery 1c is different from the all solid state batteries 1 to 1b and further includes a protective layer 30 covering at least a portion of a sintered body 10, first and second external electrodes 15 and 16, and first and second metal members 17 and 18. However, mounting portions 17c and 18c are not provided with the protective layer 30. By providing the protective layer 30, the sintered body 10 and the external electrodes 15 and 16 can be protected from moisture contained in the outside air. Even when stress is applied to the all solid state battery 1c, it is possible to prevent the sintered body 10 and the external electrodes 15 and 16 from being damaged.

A thickness of the protective layer 30 is not particularly limited, but is preferably 5 μm to 100 μm, more preferably 10 μm to 50 μm, and still more preferably 30 μm to 50 μm. By setting the thickness of the protective layer 30 in this range, the sintered body 10 and the external electrodes 15 and 16 can be suitably protected.

A water vapor permeability of the protective layer 30 measured at 1 atm, 60° C., and 85 Rh % by a differential pressure method is preferably less than 10⁻¹ g/m².day, more preferably less than 10⁻² g/m².day, and still more preferably less than 10⁻³ g/m².day. By providing the protective layer 30 as described above, it is possible to effectively suppress intrusion of moisture contained in the outside air.

The protective layer 30 preferably contains, as a main component, an inorganic substance containing at least one selected from the group consisting of Si, Li, Al, and Mg. The “main component” refers to a component contained in the protective layer 30 at 60% by volume or more.

### Summary of Embodiment

The all solid state battery according to the embodiment includes a sintered body, a first external electrode, a second external electrode, a first metal member, and a second metal member. The sintered body has a first internal electrode, a second internal electrode, and a solid electrolyte layer. The second internal electrode faces the first internal electrode with the solid electrolyte layer is between the first internal electrode and the second internal electrode. The first external electrode is on the surface of the sintered body and is electrically connected to the first internal electrode. The second external electrode is on the surface of the sintered body and is electrically connected to the second internal electrode. The first metal member is electrically connected to the first external electrode and has a first reflow-mounting portion. The second metal member is electrically connected to the second external electrode and has a second reflow-mounting portion. A first wet plating layer is on at least a portion of a surface of the first reflow-mounting portion, and a second wet plating layer is on at least a portion of a surface of the second reflow-mounting portion (i.e., a wet plating layer is provided on at least a portion of each of the first and second metal members).

Generally, when an all solid state battery is reflow-mounted on a mounting board or the like using solder, a wet plating layer for bonding with solder is required. In the all solid state battery according to the embodiment, the first and second metal members are provided with the wet plating layer, and the first and second metal members are bonded to solder during reflow mounting. Thus, there is no need to provide the wet plating layer in the first and second external electrodes. Thus, there is no possibility that entry of a plating solution inside the sintered body, which may occur when the wet plating layers are formed in the first and second external electrodes, may occur. Thus, desired characteristics can be obtained even when the all solid state battery according to the embodiment is reflow-mounted using solder.

The reflow-mounting portions are portions to be soldered at the time of reflow mounting, that is, a portion to be soldered (soldered portion) of an all solid state battery when the all solid state battery is reflow-mounted on a mounting board or the like.

In the all solid state battery according to the embodiment, preferably, the sintered body has first and second principal surfaces extending along a length direction and a width direction of the sintered body, first and second end surfaces extending along the width direction and a thickness direction of the sintered body, and first and second side surfaces extending along the length direction and the thickness direction of the sintered body, the first external electrode is on the first end surface, the second external electrode is on the second end surface, each of the first and second metal members has a connecting portion, an extending portion extending from the connecting portion along the thickness direction, and a mounting portion extending from a tip of the extending portion along the length direction, the connecting portion of the first metal member is connected to the first external electrode, the connecting portion of the second metal member is connected to the second external electrode, the mounting portion of the first metal member is the first reflow-mounting portion, the mounting portion of the second metal member is the second reflow-mounting portion, the first wet plating layer is on a surface opposite to the sintered body in a thickness direction of the mounting portion of the first metal member, and the second wet plating layer is on a surface opposite to the sintered body in a thickness direction of the mounting portion of the second metal member.

In the all solid state battery according to the embodiment, it is preferable that at least a portion of the first reflow-mounting portion overlaps the sintered body in a plan view of the all solid state battery, and at least a portion of the second reflow-mounting portion overlaps the sintered body in the plan view of the all solid state battery.

The all solid state battery according to the embodiment preferably further includes a protective layer covering at least a portion of the sintered body, the first and second external electrodes, and the first and second metal members. In that case, the water vapor permeability of the protective layer measured at 1 atm, 60° C., and 85 Rh % by the differential pressure method is less than 10⁻¹ g/m².day, and the protective layer preferably contains, as a main component, an inorganic substance containing at least one of Si, Li, Al, and Mg.

In each of the first and second metal members, the first and second wet plating layers comprise: (1) a laminate of an Ni plating layer on the at least the portion of the surface of the first and second reflow-mounting portions, a Pd plating layer on the Ni plating layer, and an Au plating layer on the Pd plating layer, (2) a laminate of an Ni plating layer on the at least the portion of the surface of the first and second reflow-mounting portions, an Ag plating layer on the Ni plating layer, an Sn plating layer on the Ag plating layer, or (3) a laminate of an Ni plating layer on the at least the portion of the surface of the first and second reflow-mounting portions, an Sn plating layer on the Ni plating layer, and an Au plating layer on the Sn plating layer.

In the all solid state battery according to the embodiment, it is preferable that each of the first and second external electrodes does not have the wet plating layer in direct contact therewith.

The all solid state battery according to the embodiment has the following configuration. Referring to FIG. 1, in the width direction, the size of the first metal member is smaller than the size of the first external electrode, and in the width direction, the size of the second metal member is smaller than the size of the second external electrode.

The all solid state battery according to the embodiment has the following configuration. Referring to FIGS. 2 and 5, the mounting portion (the portion to be reflow-mounted) of the first metal member extends along the length direction toward the mounting portion (the portion to be reflow-mounted) of the second metal member, and the mounting portion of the second metal member extends along the length direction toward the mounting portion of the first metal member.

The all solid state battery according to the embodiment has the following configuration. Referring to FIGS. 2 and 5, a gap is formed between the mounting portion (the portion to be reflow-mounted) and the sintered body.

The all solid state battery according to the embodiment has the following configuration. Referring to FIGS. 3 and 4, the mounting portion (the portion to be reflow-mounted) of the first metal member extends along the length direction toward an opposite side of the mounting portion (the portion to be reflow-mounted) of the second metal member, and the mounting portion of the second metal member extends along the length direction toward an opposite side of the mounting portion of the first metal member.

The all solid state battery according to the embodiment has the following configuration. Referring to FIGS. 2 to 5, the first metal member (the connecting portion of the first metal member) is fixed to the first external electrode, and the second metal member (the connecting portion of the second metal member) is fixed to the second external electrode.

The all solid state battery according to the embodiment has the following configuration. Referring to FIG. 1, one of the first metal member and the second metal member has an L-shape when viewed from the first side surface side or the second side surface side, and the other metal member has an inverted L-shape.

1. An all solid state battery comprising:
a sintered body having a first internal electrode, a second internal electrode facing the first internal electrode, and a solid electrolyte layer between the first internal electrode and the second internal electrode;
a first external electrode on a surface of the sintered body and electrically connected to the first internal electrode;
a second external electrode on the surface of the sintered body and electrically connected to the second internal electrode;
a first metal member electrically connected to the first external electrode, the first metal member having a first reflow-mounting portion;
a second metal member electrically connected to the second external electrode, the second metal member having a second reflow-mounting portion;
a first wet plating layer on at least a portion of a surface of the first reflow-mounting portion; and
a second wet plating layer on at least a portion of a surface of the second reflow-mounting portion.

2. The all solid state battery according to claim 1, wherein the first wet plating layer is on an entirety of the surface of the first reflow-mounting portion, and the second wet plating layer is on an entirety of the surface of the second reflow-mounting portion.

3. The all solid state battery according to claim 1, wherein the sintered body has:
first and second principal surfaces extending along a length direction and a width direction of the sintered body,
first and second end surfaces extending along the width direction and a thickness direction of the sintered body, and
first and second side surfaces extending along the length direction and the thickness direction of the sintered body,
the first external electrode is on the first end surface,
the second external electrode is on the second end surface,
each of the first and second metal members has:
a connecting portion,
an extending portion extending from the connecting portion along the thickness direction, and
a mounting portion extending from a tip of the extending portion along the length direction,
the connecting portion of the first metal member is connected to the first external electrode,
the connecting portion of the second metal member is connected to the second external electrode,
the mounting portion of the first metal member is the first reflow-mounting portion,
the mounting portion of the second metal member is the second reflow-mounting portion,
the first wet plating layer is on a surface opposite to the sintered body in a thickness direction of the mounting portion of the first metal member, and
the second wet plating layer is on a surface opposite to the sintered body in a thickness direction of the mounting portion of the second metal member.

4. The all solid state battery according to claim 1, wherein at least a portion of the first reflow-mounting portion overlaps the sintered body in a plan view of the all solid state battery, and at least a portion of the second reflow-mounting portion overlaps the sintered body in the plan view of the all solid state battery.

5. The all solid state battery according to claim 1, wherein the first reflow-mounting portion extends away from the sintered body in a plan view of the all solid state battery, and the second reflow-mounting portion extends away from the sintered body in the plan view of the all solid state battery.

6. The all solid state battery according to claim 1, further comprising a protective layer covering at least a portion of the sintered body, the first and second external electrodes, and the first and second metal members.

7. The all solid state battery according to claim 6, wherein a water vapor permeability of the protective layer measured at 1 atm, 60° C., and 85 Rh % by a differential pressure method is less than 10⁻¹ g/m².day.

8. The all solid state battery according to claim 7, wherein the water vapor permeability of the protective layer is less than 10⁻² g/m².day.

9. The all solid state battery according to claim 7, wherein the water vapor permeability of the protective layer is less than 10⁻³ g/m².day.

10. The all solid state battery according to claim 7, wherein the protective layer contains, as a main component, an inorganic substance containing at least one of Si, Li, Al, and Mg.

11. The all solid state battery according to claim 6, wherein a thickness of the protective layer is 5 μm to 100 μm.

12. The all solid state battery according to claim 1, wherein each of the first and second wet plating layers comprises a laminate of an Ni plating layer on the at least the portion of the surface of the first and second reflow-mounting portions, a Pd plating layer on the Ni plating layer, and an Au plating layer on the Pd plating layer.

13. The all solid state battery according to claim 1, wherein each of the first and second wet plating layers comprises a laminate of an Ni plating layer on the at least the portion of the surface of the first and second reflow-mounting portions, an Ag plating layer on the Ni plating layer, and an Sn plating layer on the Ag plating layer.

14. The all solid state battery according to claim 1, wherein each of the first and second wet plating layers comprises a laminate of an Ni plating layer on the at least the portion of the surface of the first and second reflow-mounting portions, an Sn plating layer on the Ni plating layer, and an Au plating layer on the Sn plating layer.

15. The all solid state battery according to claim 1, wherein each of the first and second external electrodes does not have the wet plating layer in direct contact therewith.

16. The all solid state battery according to claim 1, wherein the first wet plating layer is on an entirety of a surface of the first metal member, and the second wet plating layer is on an entirety of a surface of the second metal member.
